(19) United States
(12) Patent Application Publication
(10) Pub. No.: US 2026/0012420 A1
(43) Pub. Date: Jan. 8, 2026

(54) SYSTEM AND METHOD FOR SPECULATIVE SOFTWARE-DEFINED NETWORKING

(71) Applicant: University of Central Florida Research Foundation, Inc., Orlando, FL (US)

(72) Inventors: Murat Yuksel, Orlando, FL (US); David Mohaisen, Orlando, FL (US); Ahmad Hariri, Orlando, FL (US)

(21) Appl. No.: 19/194,305

(22) Filed: Apr. 30, 2025

Related U.S. Application Data
(60) Provisional application No. 63/666,728, filed on Jul. 2, 2024.

(51) Int. Cl. H04L 45/76; H04L 45/00

(52) U.S. Cl. CPC H04L 45/76; H04L 45/54

(57) ABSTRACT

A system and method for speculative software-defined networking (SDN) having reinforcement learning (RL) agents trained to predict an arrival of previously unseen flows for efficient installation into a switch flow table. The RL agents of the speculative SDN learn and speculatively install the unseen flow rules into the switch flow table (SFT) of the SDN switches to avoid the additional control latency from the reactive installation of flow rules.

### CROSS-REFERENCE TO RELATED APPLICATIONS

This application claims priority to U.S. Provisional Patent Application No. 63/666,728 entitled, “A SYSTEM AND METHOD FOR SPECULATIVE SOFTWARE-DEFINED NETWORKING”, filed on Jul. 2, 2024, the entirety of which is incorporated herein by reference.

### GOVERNMENT SUPPORT STATEMENT

This invention was made with Federal Government support under 1814086 awarded by the National Science Foundation. The Government has certain rights in the invention.

### BACKGROUND OF THE INVENTION

Software-Defined Networking (SDN) is an approach to managing network resources by separating the control and data planes. SDN supports programming of the control plane and dynamic traffic management enabled by a centralized controller with a global view of the network.

SDN designs can be proactive or reactive depending on how flows are installed. Proactive SDN installs the flow rules statically before running the system and is best for policy applications. Reactive SDN installs the flow rules dynamically upon a miss during the lookup of an incoming packet, which triggers the switch to send a Packet-in message from the switch to the controller, after which the controller installs the correct flow rule in the switch flow table (SFT). Such reactive handling of flows is used for responding to failures or short-term demand spikes.

Low-latency applications, such as online gaming and augmented or virtual reality (AR/VR) have become very popular. These low-latency applications feature live interactions and require very stringent network delay constraints, e.g., 15 ms response time is needed to avoid dizziness for VR/AR applications.

Currently known proactive SDN designs are not flexible nor scalable enough to handle the traffic flow dynamics for such immersive applications since they require a priori installation of flows, and the SFTs cannot hold too many flow entries. Reactive SDN designs have the potential to address these needs. However, the time needed to install flow rules reactively is a limitation. Given that the latency between the switch and the controller is on the order of milliseconds, reducing this extra delay is necessary to accommodate emerging low-latency applications.

Accordingly, what is needed in the art is an improved SDN architecture that reduces or eliminates the latency experienced by the packets between the switch and the controller to accommodate low-latency applications.

### SUMMARY OF THE INVENTION

In various embodiments, the present invention provides a speculative software-defined networking (SDN) system and associated method of us that facilitates low-latency network applications.

In one embodiment, the present invention provides a software-defined networking (SDN) system including a plurality of SDN switches, each of the plurality of SDN switches comprising a switch flow table (SFT) for storing flow rules for the SDN switch. The system further includes an SDN controller coupled to the plurality of SDN switches. The SDN controller comprises a speculative SDN application having a plurality of reinforcement learning (RL) agents and wherein the plurality of RL agents are trained to speculate a flow rule for a previously unseen flow and to install the speculated flow rule for the previously unseen flow into the switch flow table (SFT) of one or more of the plurality of switches prior to arrival of the previously unseen flow at the one or more of the plurality of switches.

The plurality of RL agents are trained to utilize active flow rules in the SFT to speculate the previously unseen flow rules as geographically adjacent to the active flow rules.

The system further includes a reactive SDN application for installing new flow rules into the SFT following a miss at the SFT and wherein the reactive SDN application for installing new flow rules into the SFT of one or more of the plurality of switches coordinates with the speculative SDN application for installing speculative flow rules into the SFT of one or more of the plurality of switches.

In various embodiments, priority policies and a reward system are implemented in the operation of the RL agents to improve the RL agents' ability to predict the best set of flows to install in the SFT and to implement a framework to assist in the selection of a particular flow for removal from the SFT.

In another embodiment, a computer implemented method for software-defined networking (SDN) is provided. The method includes, receiving a previously unseen flow at one or more of a plurality of SDN switches, wherein the plurality of SDN switches comprises a switch flow table (SFT) for storing flow rules. The method further includes, requesting, from one or more of the plurality of SDN switches, a new flow rule for the previously unseen flow from a speculative SDN application of an SDN controller coupled to the plurality of SDN switches. The method continues by speculating by the speculative SDN application of an SDN controller coupled to the plurality of SDN switches, a speculated flow rule for the previously unseen flow and installing the speculated flow rule into the SFT of one or more of the plurality of SDN switches.

In another embodiment, the present invention provides a non-transitory computer-readable medium, the computer-readable medium having computer-readable instructions stored thereon that, when executed by a computing device processor, cause the computing device to implement a software-defined networking (SDN). The computer-readable instructions including, receiving a previously unseen flow at one or more of a plurality of SDN switches, wherein the plurality of SDN switches comprises a switch flow table (SFT) for storing flow rules. The computer-readable instructions further including, requesting, from one or more of the plurality of SDN switches, a new flow rule for the previously unseen flow from a speculative SDN application of an SDN controller coupled to the plurality of SDN switches, speculating by the speculative SDN application of an SDN controller coupled to the plurality of SDN switches, a speculated flow rule for the previously unseen flow and installing the speculated flow rule into the SFT of one or more of the plurality of SDN switches.

Accordingly, in various embodiments, the present invention provides a reactive SDN architecture enhanced with speculative flow installations by employing reinforcement learning (RL) so that the latency experienced by data packets between SDN switches and an SDN controller is reduced or eliminated.

### BRIEF DESCRIPTION OF THE DRAWINGS

For a fuller understanding of the invention, reference should be made to the following detailed description, taken in connection with the accompanying drawings, in which:

FIG. 1 illustrates the Reactive SDN process currently known in the art.

FIG. 2 illustrates the Speculative SDN process, in accordance with an embodiment of the present invention.

FIG. 3 illustrates the integrative Speculative and Reactive SDN framework, in accordance with an embodiment of the present invention.

FIG. 4 illustrates DQN agents in the RL framework: An example with N=10 and U=5, in accordance with an embodiment of the present invention.

FIG. 5A is a graphical illustration of the average hit rate for Speculative SDN vs. the hit rate for Reactive SDN for trace 1.

FIG. 5B is a graphical illustration of the average hit rate for Speculative SDN vs. the hit rate for Reactive SDN for trace 2.

FIG. 5C is a graphical illustration of the average hit rate for Speculative SDN vs. the hit rate for Reactive SDN for trace 3.

The figures illustrate only example embodiments therefore are not to be considered as limiting the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION OF THE INVENTION

Software-Defined Networking (SDN) separates the control and data planes which allows better programmability of the control plane to predict, route, and schedule the traffic at the data plane. As a more flexible approach, Reactive SDN installs the correct flow rule dynamically when a new flow arrives. This design helps respond to application dynamics and makes Reactive SDN a strong candidate for responding to the needs of emerging low-latency applications. Low-latency applications such as online gaming and AR/VR have become very popular, and they represent a large portion of the internet traffic. However, low-latency applications require millisecond-level response times for an acceptable quality of experience. An existing limitation for Reactive SDN is that its operation necessitates a miss upon the arrival of a new traffic flow where each miss in Reactive SDN causes a Packet-in message to be sent from the switch to the SDN controller, which increases the overall delay the data packets experience. To attain millisecond-level packet delays, reducing the miss rate by predicting the arrival of flows and installing the necessary flow rules at the switch before the flows arrive dynamically is necessary to prevent latency.

Reinforcement Learning (RL) is an approach whereby agents interact in an environment by making actions to receive rewards in order to accomplish tasks, such as forecasting and robotics applications. RL has great potential in predicting the arrival of flows where agents can learn and install the right flow rules to avoid the extra latency in the reactive installation of the flow rules. A flow is a sequence of packets that share common characteristics, such as source/destination IP address, port, etc. The packets of a flow are treated as a single unit by the SDN controller and flows are defined by rules in the SFT of the SDN switch. The SDN controller installs the rules that determine how packets matching the flow are handles.

In various embodiments, the present invention proposes an SDN design referred to as ‘speculative’ that is designed to overcome the Reactive SDN limitations for applications that require fast response. A novel Speculative SDN framework is provided that incorporates RL to predict the arrival of flows that may not have been seen before. It is shown that the RL agents can learn and speculatively install the unseen flow rules to avoid the additional control latency due to the reactive installation of the flow rules. Focusing on the case of a known set of flows, a reward function is designed to increase the efficacy of the RL agents' capability in predicting the best set of flows to install in the switch's flow table (SFT). A priority policy is implemented to assist the framework functionality when selecting a flow for removal. An approach is built that uses the spatial locality information for the flows to help the agents when speculating the previously unseen flows.

Table I compares the proactive and reactive designs against the speculative SDN design of the present invention in terms of several factors.

TABLE I
Speculative vs. Traditional SDN types

| | | | | Specu- |
|---|---|---|---|---|
| Feature | Proactive | Predictive | Reactive | lative |
| Policy enforcement | [symbol] | [symbol] | [symbol] | [symbol] |
| Failure handing | [symbol] | [symbol] | [symbol] | [symbol] |
| Traffic engineering | [symbol] | [symbol] | [symbol] | [symbol] |
| Dynamic flow installation | [symbol] | [symbol] | [symbol] | [symbol] |
| Unseen flow installation | [symbol] | [symbol] | [symbol] | [symbol] |
| Low control latency | [symbol] | [symbol] | [symbol] | [symbol] |
| Protected against attacks | [symbol] | [symbol] | [symbol] | [symbol] |

Since the flows are statically predefined, Proactive SDN cannot handle dynamic failures. In contrast, Reactive SDN can respond to failures since the controller reacts to incoming traffic flows and dynamically installs new flow rules on-the-fly. Similarly, Speculative SDN can also handle failures and install flows dynamically by training its RL agents for reactive behavior approach. Proactive and Reactive SDN designs cannot install flows that have no historical appearance, while Speculative SDN can install previously unseen flows that are geographically adjacent to the active flows approach. Proactive SDN offers minimal latency resulting from control decisions since no interaction takes place between the switch and the controller when processing the packets, which regularly happens in Reactive SDN and results in high control latency for every miss during the SFT lookup. Speculative SDN is built for low control latency because of the RL agents' ability to install flows before they arrive and hence avoid the switch-controller interactions for packet processing.

A major challenge in Speculative SDN is its relatively higher vulnerability to attacks. With predefined set of flows in the SFT, Proactive SDN is safe against denial-of-service (DOS) attacks. The controller is protected against DoS since every packet causing a miss at the SFT is dropped at the switch. Reactive and Speculative SDN designs are prone to DOS attacks since Reactive SDN involves the controller for every previously unseen flow and Speculative SDN installs previously unseen flows, which may be malicious. Strong filtration mechanisms and precautionary measures are needed to safeguard Speculative SDN from malicious flows.

The framework of the present invention differs from known SDN hybrid designs as the goal is to install the correct flows into the SFT in advance of the arrival of a previously unseen flow. The RL agents are designed to learn about the active flows and install their geographically adjacent (but previously unseen) flows that have no history of appearance in the network. Additionally, the work presented here differs from previous studies since it predicts flow arrivals instead of predicting traffic demand patterns. To the best of the inventor(s) knowledge, this work is the first to predict the arrival of previously unseen flows, by utilizing deep reinforcement learning methods, and installing the flow rules into the SFT prior to the arrival of the previously unseen flows.

In a Reactive SDN setup, the process of reactive flow rule installation due to a miss at the SFT causes additional delay to the forwarding of packets. Specifically, when a packet of a flow arrives at the switch and causes a miss during the lookup for a rule match at the SFT, a Packet-in message is sent to the controller. The controller responds with a Flow Mod message to install the new flow's rule to SFT. After that, the switch either forwards the packet toward its destination or drops it depending on its configuration. This additional reactive flow rule installation delay takes place when (i) a flow arrives for the first time or (ii) the flow's rule is aged out of the flow table because its Idle Timer expired, and the next packet of the flow causes a miss. Reactive SDN configurations cannot avoid the former but try to minimize the latter by tuning the Idle Timer. Although Reactive SDN offers great flexibility in handling dynamic traffic patterns (e.g., flows are installed as they show up), these flow installation delays of Reactive SDN are not acceptable for the recent low-latency applications with stringent delay requirements, e.g., 15 ms for VR/AR.

Avoiding the additional delays due to a miss at the switch requires static installation of flow rules, which is practiced in Proactive SDN. However, this approach requires a priori installation of flow rules and is not flexible enough to respond to the dynamism of the traffic flows. In an effort to keep the best of both worlds (i.e., the flexibility of Reactive SDN and the low-latency packet forwarding of Proactive SDN), in accordance with various embodiments of the present invention it is proposed to use RL to predict the arrival of flows before they show up and speculatively install the flows into the SFT.

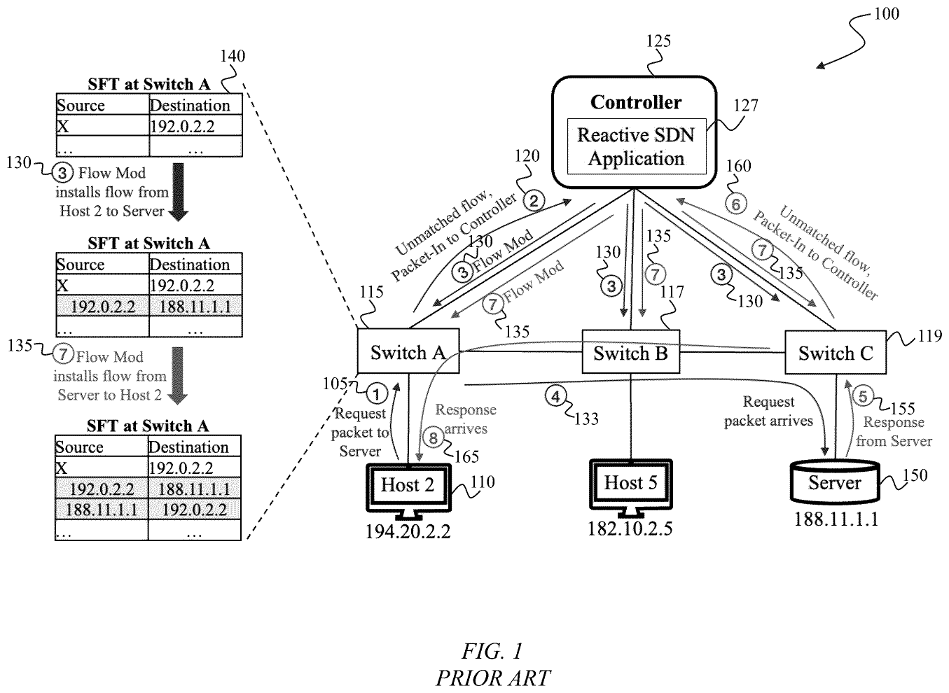

The potential improvement from the speculative SDN framework in reducing the delay is now illustrated and compared to a reactive setup in a canonical example. Consider a scenario where a new user/host is requesting a piece of data from a server, e.g., a VR/AR gaming server. FIG. 1 shows a Reactive SDN system 100, as is known in the art. The controller 125 of the Reactive SDN system 100 includes a Reactive SDN application 127 to assist in the routing of the network flows. At a first step 105, a request packet from Host 2 110 destined for the Server 150 arrives at Switch A 115. At a second step 120, following a lookup at the SFT 140 at Switch A 115 for a flow rule match, Switch A 115 sends a Packet-in message to the controller 125 since there is no flow rule match in the SFT 140 at Switch A 115. At a third step 130, the controller 125 sends the Flow Mod message to Switch A 115, Switch B 117 and switch C119 for installing the flow rule to configure the path for the flow of the request packet 105 from Host 2 110 to the Server 150. At a fourth step 133, the request packet is sent from Host 2 110 and arrives at the Server 150. At a fifth step 155, the Server 150 sends a response to Switch C 119. At a sixth step 160, following a lookup at the SFT of Switch C 119 for a flow rule match for the response from the Server 150, Switch C 119 sends a Packet-in message to the controller 125 since there is no flow rule match in the SFT at Switch C 119. At a seventh step 135, the controller 125 sends the Flow Mod message to Switch C 119, Switch B 117 and Switch A 115 for installing the flow rule to configure the path for the flow of the response from the Server 150 to Host 2 110. At an eighth step 165, the response is sent from the Server 150 and arrives at Host 2 110. As such, in accordance with the operation of SDN illustrated in FIG. 1, during the handling of the request from Host 2 110 and the response from the Server 150, Switch A 115 and Switch C 119 with both trigger a Packet-in to the controller 125 which causes additional delay, which is undesirable.

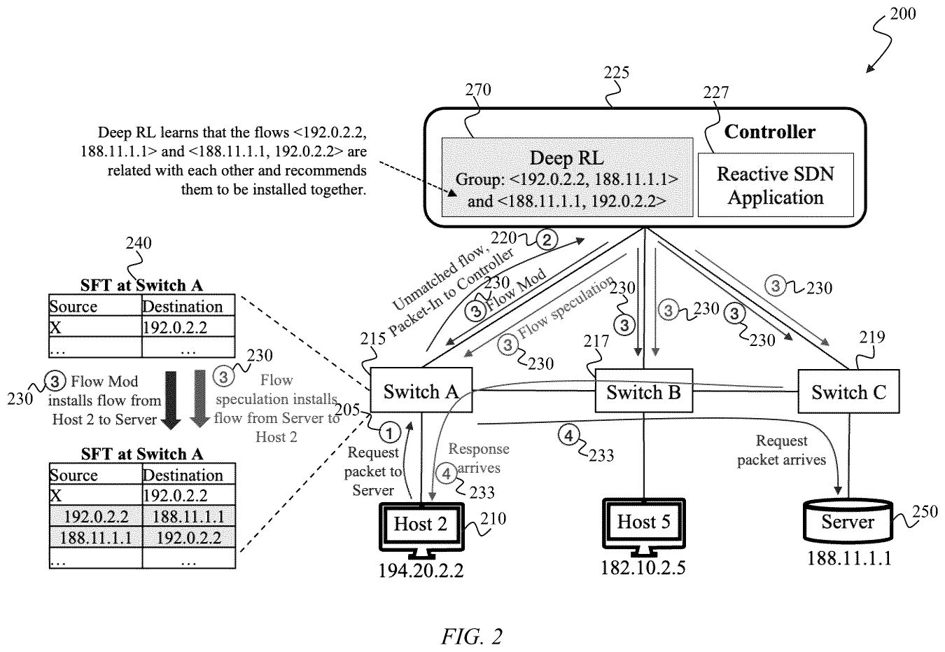

In contrast with the reactive SDN system illustrated in FIG. 1, the controller 225 of the speculative SDN system 200 illustrated in FIG. 2 includes both a reactive SDN application 227 and a RL agent 270 to assist in the routing of the network flows. In the operation of the speculative SDN system 200 of FIG. 2, at a first step 205, a request packet from Host 2 210 destined for the Server 250 arrives at Switch A 215. At a second step 220, following a lookup at the SFT 240 at Switch A 215 for a flow rule match, Switch A 215 sends a Packet-in message to the controller 225 since there is no flow rule match in the SFT 240 at Switch A 215. At a third step 230, the controller 225 sends the Flow Mod message to Switch A 215, Switch B 217 and switch C219 for installing the flow rule to configure the path for the flow of the request packet 205 from Host 2 210 to the Server 250. Also at the third step 230, the controller 225 sends the Flow Speculation message to Switch A 215, Switch B 217 and Switch C 219 for installing the flow rule to configure the path for the flow from the Server 250 to Host 2 210. At a fourth step 233, the request packet is sent from Host 2 210 and arrives at the Server 250 and the response is sent from the Server 250 and arrives at Host 2 210. As such, in accordance with the operation of speculative SDN 200 illustrated in FIG. 2, during the handling of the request from Host 2 210 and the response from the Server 250, the RL agent 270 of the Controller 225 learns that the flows from Host 2 210 to the Server 250 and from the Server 250 to Host 210 are related to each other and therefore recommends that they be installed together at the SFTs of Switch A 215, Switch B 217 and Switch C 219, thereby eliminating the delay that is inherent in the reactive SDN system shown in FIG. 1.

The speculative SDN of the present invention is able to predict the arrival of the response from the Server 250 to Host 2 210 ahead of time and install the flow rule at the switches, thus avoiding the additional delay from the second exchange of the Packet-in and Flow Mod messages between the switches and the controller. This prediction will be acquired by the RL agent 270 at the controller 225.

The process of reactive flow rule installation can be improved with RL that rewards hits at the SFT and also rewards speculative installations that have a higher chance of increasing the hit rate in the future, thereby reducing the delay time for packet processing. To capture the temporal locality patterns, deep RL (DRL) is used and multiple DRL agents are implemented for scalability. The RL agents 270 will be responsible for speculative flow rule installation along with the Reactive SDN application 227 behavior that installs flows causing misses.

At a high level, the purpose of installing a flow rule to the SFT of the switch is to minimize the miss rate, i.e., maximize the hit rate of the packets passing through the switch. To formalize the problem, a time duration divided into intervals 1 . . . T is considered, each with length Δt. At the end of each interval, it is assumed that the flow rules in the SFT are revised and, hence, speculated flows can be installed. Let F be the set of all flows that can arrive to the switch under consideration. Let λ(t, f), t=1 . . . T be a stochastic counting process for the number of packet arrivals from flow f∈F. Moreover, let H(t, Fₜ) be the sum of hits to the set flows in Fₜ at time epoch t, i.e., H(t, Fₜ)=Σ_{f∈T}_{ₜ}λ(t, f). Then, the problem of maximizing the hit rate is written as:

$$MAX\_HIT \_RATE = \begin{matrix}max \\ {F}_{t ∈ ℱ , t = 1 … T}\end{matrix} {\sum }_{i = 1}^{T} H ( i , {F}_{i} ) \qquad ( 1 )$$

$$such that \vert {F}_{t} \vert \leq M , t = 1 … T \qquad ( 2 )$$

where Fₜ is the set of flow rules in the SFT at time t and M is the capacity of the SFT in terms of the number of flow rules.

The MAX_HIT_RATE problem formulation above does not capture every aspect of the speculative SDN design. In practice, not all the flows in Fₜ can be speculated. This is because flows that have been in the SFT in the previous time interval cannot be speculated as they were there already. A more careful speculative SDN design problem is to maximize the hit rate while also minimizing the number of speculated flows. Since each speculated flow makes the switch perform a forwarding action on the packets of that flow, the speculated flows pose a security risk if they were not vetted beforehand. Hence, if [symbol] includes potentially malicious flows, the number of speculated flows should be kept to a minimum. To facilitate the discussion, the following formal definitions are made:

Definition 1. Speculated Flow: A speculated flow is a flow f∈F installed in the SFT by the agents at time t and did not generate packets during the time duration (t−Δt, t)·n Let

$${F}_{t}^{s} ⊆ {F}_{t}$$

be the part of Fₜ composed of speculated flows. One can define the following metrics to evaluate the benefit of speculation:

Definition 2. Speculation Rate: This rate is the fraction of the SFT that is composed of speculated flows, i.e.,

$$\vert {F}_{t} \vert / {F}_{t} .$$

Definition 3. Speculation Efficiency: This efficiency is the improvement in the hit rate per additional speculation. This can be calculated by the ratio of the additional hits achieved by the speculated flows to the average speculation rate:

$$S E = ( \frac{{\sum }_{i = 1}^{T} H ( i , {f}_{i} )}{{\sum }_{i = 1}^{T} H ( i , \{ {F}_{i} ∖ {F}_{i}^{s} \} )} - 1 ) / ( \frac{1}{T} {\sum }_{i = 1}^{T} \frac{\vert {F}_{i}^{s} \vert}{\vert {F}_{i} \vert} ) \qquad ( 3 )$$

A key challenge in enabling speculative flow additions to an SDN switch is to coordinate with the operation of the Reactive SDN. The Reactive SDN installs a new rule for each newly arriving flow. This is done after the first packet of the new flow causes a miss at the SFT. When integrating speculation of flows into the SFT, one should not disrupt the regular operation of Reactive SDN. A pitfall, for example, is that the speculated flows replace flows that were recently installed by the Reactive SDN operation. For proper integration of speculated flows to the SFT, two timescales are utilized:
Reactivity Time Interval (RTI): It is assumed that installation of a new flow due to Reactive SDN operation takes hundreds of microseconds to tens of milliseconds. This is typically the amount of time needed for the switch to send the Packet-in to the SDN controller and for the controller to subsequently install the new flow via a Flow Mod message to the switch.
Learning Time Interval (LTI): Since the agents may need to perform large computations to update their models and come up with a speculated set of flows, they can take a longer time than the switch-controller interaction in the Reactive SDN operation. Hence, it is assumed that RL agents learn at a timescale greater than or equal to the RTI, e.g., a few to hundreds of milliseconds. This also allows the learning to be offloaded to cloud environments working as backend support to the SDN controller.

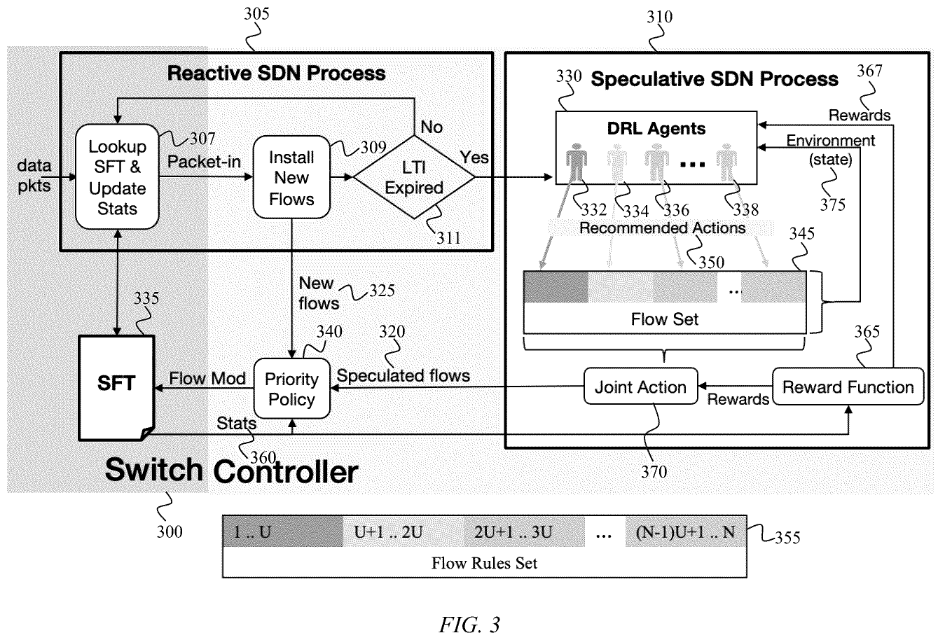

FIG. 3 shows how the reactive SDN process 305 and speculative SDN process 315 of the switch controller 300 work together. In this embodiment, upon receiving data packets, the reactive SDN process 305 first performs a lookup of the SFT and updates statistics 307 of the switch controller and then issues a Packet-in to install new flows 309. The reactive SDN process 305 further includes determining whether or not the Learning Time Interval (LTI) has expired 311. If the LTI has expired, the speculative SDN process 310 is initiated as described below.

Since speculated flows 320 are the ones that have not had any packet arrivals but are being predicted by the Deep RL agents 330 to be arriving soon, it becomes necessary to establish a systematic way of resolving potential conflicts between new flows 305 installed by Reactive SDN 305 and the ones being proposed by the DRL agents 330 of the speculative SDN 310. In particular, when installing speculated flows 320 (which happens at every LTI) or new flows 325 (which happens at every RTI), one considers the ‘priority’ of flows in addition to how frequently they are used. When the SFT 335 at a switch controller 300 is full, a victim flow needs to be selected before a new flow 325 or a speculated flow 320 can be installed. The SFT 335 size is tuned based on the averaged incoming flows traffic rate. The priority policy 340, as shown in FIG. 3, determines this victim selection and how the new 325 or speculated flows 320 are prioritized for being placed in the SFT 335.

Selecting the Least Recently Used (LRU) flow as the victim is the legacy approach. Here the LRU policy is approximated by implementing the Least Frequently Used (LFU) policy over a time window, i.e., LFU Window. The LFU policy is more practical than LRU in an SDN setup because it is less complex and uses counters to compare the flows instead of timestamps. In this design, the LFU Window is set to 10×RTI.

A problem that arises with the LFU policy is that it can remove a very active and recently installed new flow that has few packet arrivals yet. This can cause a speculated flow 320 to replace a new flow 325 that was just installed by the Reactive SDN process 305. To resolve this conflict, the priority of the flows is used when selecting a victim. The priority of the new flows 325 installed by the Reactive SDN process is set to 1 and the speculated flows 320 installed by the speculative process is set to 0.5. Since the speculated flows 320 are less important as they are just trying to help the reactive process (to decrease the packet delay), a low priority is assigned to them. To capture the temporal locality, all the flows in the SFT 335 are aged by multiplying their priority with Flow Aging Factor, a value between 0.5 and 1, at every LTI. This aging process allows new flows 325 installed by the Reactive SDN 305 process to become a candidate for replacement if they do not generate traffic. The RL agents 330 in the speculative SDN process 310 will learn which flows generate more traffic over time and will suggest them as speculated flows 320. Hence, when a flow in the SFT 335 has a priority greater than 0.5 and is also suggested as a speculated flow, its priority is increased or set to 1. This makes sure new flows that were installed by the Reactive SDN process 305 and continued generating more packets will have a priority greater than 0.5 during their lifetime. Given this priority policy, the victim flow is chosen as the LFU flow among the flows with priority less than or equal to 0.5.

To solve the MAX_HIT_RATE problem, the multi-agent DRL 330 is used for speculating the appropriate flow set

$${F}_{t}^{s} ⊆ {F}_{t} ,$$

into the SFT 335 every LTI. Given |Fₜ|=N flows in the flow set (i.e., the set of all possible flows), one assigns U=[1, N) flows to a DRL agent 332, 334, 336, 338. This setup results in K=┌N/U┐ agents in the design. Each flow in Fₜ is marked with a binary selector, indicating whether or not its agent 332, 334, 336, 338 is recommending it to be speculated into the SFT 335. These binary values compose the current state for the agents 332, 334, 336, 338. Each agent observes the entire flow set Fₜ 345 as the current state and makes an action recommendation 350 for the flows it is responsible for. Moreover, each agent 332, 334, 336, 338 is responsible for a subset of flows 355 and it chooses an action to either select or deselect flows in its group of flows, where select means to recommend the flow to be speculated into the SFT 335. Given the action recommendations from each agent, one can, then, apply a joint action policy to select the subset of the recommended flows to be speculated into the SFT 335. This is necessary since the SFT 335 size is likely to be smaller than the number of flows recommended by the agents 332, 334, 336, 338. Once the SFT 335 is updated with the speculated flows 320 (after being filtered through the priority policy in the previous section), the hit or miss statistics 360 are reported back to the agents 332, 334, 336, 338 via a reward function 365. Each DRL agent 332, 334, 336, 338 observes the reward 367 obtained for its action. Each flow is given a reward based 367 on the number of hits or misses it incurred. In addition to these per-flow rewards, each agent 332, 334, 336, 338 uses the current state Fₜ for learning and making its new action, i.e., deciding which one of its associated flows is recommended. Multi agent RL 330 are used over single agent RL because multi agents can utilize the neural networks training time since each agent will be responsible for a smaller flow set, and better chances of getting rewards per agent.

State. The state 375 for the RL agents 332, 334, 336, 338 is the entire flow set, Fₜ, where each flow has an ID and a corresponding binary value indicating whether it is recommended for inclusion in the SFT 335 as a speculated flow 320 or not. The entire state 375 is made available to the agents 332, 334, 336, 338, and hence establish a ‘fully observable environment’. This means that the switch controller 300 must know the ID (e.g., source and destination IP pair) of all possible flows. In practice, the controller 300 may only know a subset of all possible flows, corresponding to a ‘partially observable environment’, which is a common design approach in multi-agent RL. Since the focus of this work is not the RL models, a fully observable environment discussion is continued.

Action. Each agent 332, 334, 336, 338 can choose a binary action, i.e., select or deselect, for each flow in its assigned group. Hence, an agent's action space size is 2″. By selecting a flow, the agent is recommending that flow to be speculated into the SFT. Since each agent 332, 334, 336, 338 is making these recommendations independently, a joint action policy 370 is needed. As such, a subset of the recommended flows is selected by comparing their rewards attained in the last LTI. To do so, for each flow, one maintains a reward value, calculated based on the hits and misses generated by that flow. Thus, the joint action policy 370 of the agents is to select the highest-reward flows among the flows recommended by the agents 332, 334, 336, 338. These highest-reward recommended flows become the speculated flows. The quota for the speculated flows 320 is determined by counting the number of flows in the SFT 335 with a priority less than 0.5.

Reward. The reward function 365 is supposed to reward the agents 332, 334, 336, 338 when their actions cause an increase in the hit count and punish them when causing a miss. To calculate the reward for each agent, one maintains a reward value for each flow in the flow set, Fₜ. The reward for an agent is the sum of the rewards for the flows that the agent is responsible for. To calculate the reward r^{t+1}[i] of a flow Fₜ[i], i∈[1 . . . N], at the beginning of the (t+1)^{th} LTI, one applies the following ordered steps:
Step (1): exponentially decay r^{t}[i] by multiplying it with Reward Aging Factor, a value in the range (0,1),
Step (2): increment r^{t}[i] for every hit or miss the flow Fₜ[i] incurred, and
Step (3): for every hit or miss generated by a flow Fₜ[i], j+i, j≠[1 . . . N] such that |j−i|≤Spatial Impact Range, add reward to r^{t}[i] by the amount Spatial Reward Decay Factor^{|j-1|} where Spatial Reward Decay Factor is a value in (0,1).

The intuition for Step (1) is to ensure that flows that stopped generating hits (or rewards) are phased out. Step (2) increases the reward of the flow for every hit or miss. Since the RL agent is expected to predict, misses should also increase the flow's reward as they mean the flow is here already and the agent is going to choose flows with higher reward potential. Step (3) aims to capture spatial locality with the assumption that the flows in Fₜ are ordered in a manner that follows a spatial correlation. Following this assumption, Step (3) rewards the flows that are close to the flows that generate traffic. This will increase the likelihood that the agents will speculate flows that are closer to the active flows, i.e., the flows that are generating traffic. The range of this ‘spatial reward’ is limited by Spatial Impact Range. With the worst-case assumption that active flows are uniformly distributed across the flow set, Spatial Impact Range is set to N/ [symbol] # of active flows [symbol] . The [symbol] # of active flows [symbol] is calculated on the fly by monitoring the packet arrivals during the last LTI.

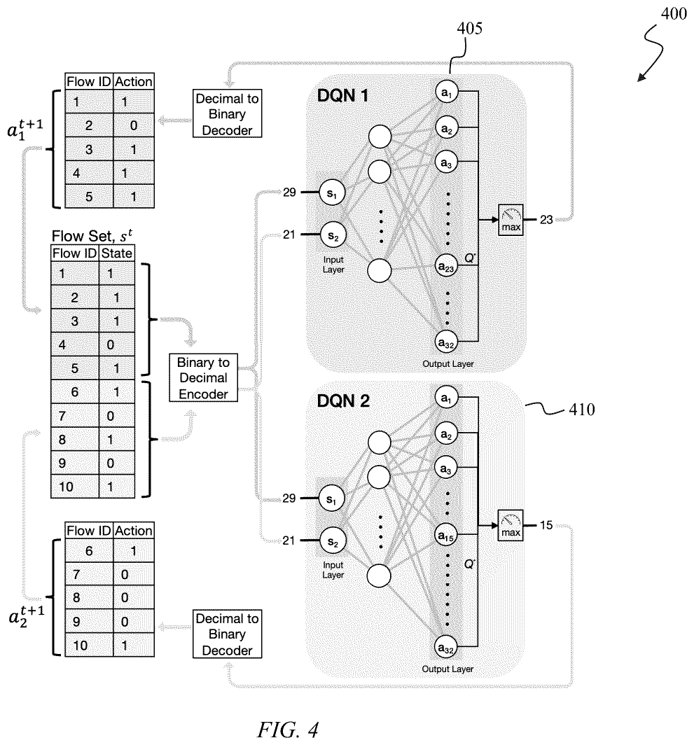

To train the RL agents, the DQN algorithm is used, which uses Q-learning along with a Deep Neural Network (DNN) to model the Q table, which includes the learned Q values for state-action pairs. DQNs are very efficient in tackling problems with large state-action space, which causes a large Q table for traditional RL methods like Q-learning. In this problem, the state for an agent is binary values (indicating selection or deselection of a flow) in the flow set F_{t1×N}, and each agent is responsible for U flows. Hence, each RL agent's state-action space is 2^{N}×2^{U}, which is prohibitively large for practical scenarios as N can be very large. To reduce the state input size, the U binary values in Fₜ are encoded for the flows corresponding to an agent to a decimal number. Then, to capture the entire state in Fₜ, the per-agent decimal values are fed to the DNN as the state. This approach reduces the number of state inputs for a DQN agent's DNN to K decimal values (each in 1 . . . 2^{U}), which makes the input layer size of DNN to be K. DNN's output layer size is configured to the action space size for an agent, i.e., 2^{U}. DQN selects the output with the highest Q value (as will be detailed below) as the action, which has a unique ID in the action space of 1 . . . 2^{U}. This chosen action ID is then decoded to binary, and the binary values are updated in the flow set corresponding to the agent. In addition to the input and output layers, the DQN agents are configured with a 10-neuron middle layer. FIG. 4 shows a sample setup of DQN agents 400 in the RL framework.

Each DON agent 405, 410 runs its own policy and attempts to learn the best action by itself to maximize the total reward for the flows it is assigned to. For agent k at LTI interval t, an ϵ-greedy policy is constructed on the Q^{π} values so as to maximize the reward

$${r}_{k}^{t} : π *= {argmax}_{{a}_{k}} Q * ( {s}^{t} , {a}_{k}^{t} ) \qquad ( 4 )$$

which will take actions uniformly at random with ϵ probability. Here, s^{t}=F_{y} is the current state (i.e., the entire flow set's binary selection values) and

$${a}_{k}^{t} = 1 … {2}^{U}$$

are the actions to be taken by the agent k. To train the DQN 405, 410, the DNN is updated using the Bellman equation:

$$Q ( {s}_{k}^{t} , {a}_{k}^{t} ) + = α [ {r}_{k}^{t} + γ max ( Q ( {s}_{k}^{t + 1} , {a}_{k}^{t + 1} ) ) - Q ( {s}_{k}^{t} , {a}_{k}^{t} ) ] \qquad ( 5 )$$

where a is the learning rate, y is the discount factor

$${r}_{k}^{t} = {\sum }_{v = ( k - 1 ) N + 1 … kU} {r}^{t} [ v ]$$

is the total reward from the flows assigned to the agent k, and

$${s}_{k}^{t + 1}$$

is the last state as a result of the action in LTI t. Experience replay buffer is then used, which stores the recent transitions of the DNN for efficient training. Specifically, the newest sample, as a tuple

$$\{ {s}_{k}^{t} , {a}_{k}^{t} , {r}_{k}^{t} , {s}_{k}^{t + 1} \} ,$$

replaces the oldest sample.

A discrete-event Python simulator of the Speculative SDN and Reactive SDN setups is developed to compare their performance. The necessary data structures are constructed and processing the packets trace from the beginning to the end while simulating the reactive and/or speculative SDN processes as previously detailed. These SDN designs are simulated over pcap files of real-world traffic traces for IoT applications by treating them as UDP packets. The traces are obtained from a UNSW Sydney study and includes 20 IoT traffic traces collected for network security and privacy issues.

Three fields in the packet traces are considered: packet arrival timestamp, source address, and destination address. The trace files are parsed to find the distinct pairs of source and destination addresses and assign an ID number to each distinct pair to obtain the full flow set, the size of which is the N. The first 200 seconds are read from these traces which yield around 300K, 300K, and 500K packets as well as 651, 923, and 1,046 distinct source-destination flow pairs, respectively, for the three traces, which are named trace1, trace2, and trace3. When gathering statistics, the results after 50 seconds are used when the SDN methods converge to steady-state.

A factor that impacts the outcome is the way flows are ordered in the flow set Fₜ. This ordering was performed in three ways: (1) trace-based, i.e., the flows are ordered in the order they appear in the trace, (2) source-based, i.e., the flows are ordered according to their source IP address, and (3) destination-based, i.e., the flows are ordered according to their destination IP address. The trace-based method is impractical as it requires knowing the future and is therefore used as a benchmark. Table II shows the parameters used in the simulations. For each traffic trace, the simulations were repeated four times with different seed values and the average was obtained.

TABLE II
Simulation parameters
Simulation Parameters

| | |
|---|---|
| Switch Flow Table size | 30 |
| Learning Time Interval (LTI) | 0.1 s |
| Reactivity Time Interval (RTI) | 0.01 s |
| Flow Aging Factor | 0.5 |
| LFU Window | 10*LTI |
| RL: # of flows, N | 651, 923, 1,046 |
| RL: # of flows per agent, U | 10 |
| RL: Reward Aging Factor | 0.9 |
| RL: Spatial Reward Decay Factor | 0.9 |
| DQN: # of DNN layers | 3 |
| DQN: Learning Rate | 0.9 |
| DQN: ∈ | 0.1 |
| DQN: Discount Factor | 0.9 |

The purpose of the evaluation includes (i) understanding how much potential improvement in terms of packet latency is possible with the Speculative SDN and (ii) quantifying the efficiency of speculation. For the former, the hit rate achieved by Speculative SDN against Reactive SDN is compared. For the latter, the speculation efficiency is inspected, defined in Eq. (3).

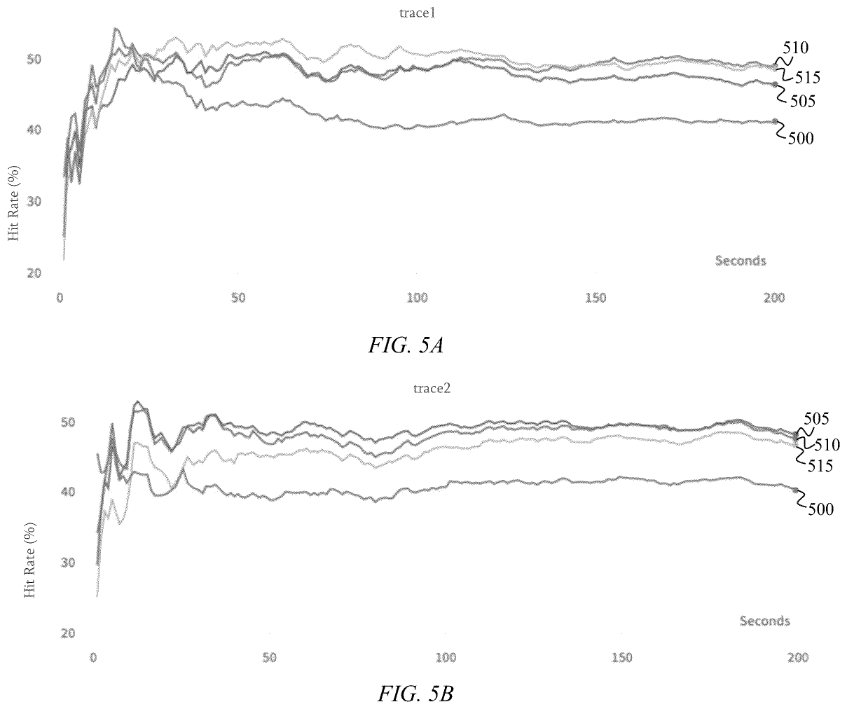

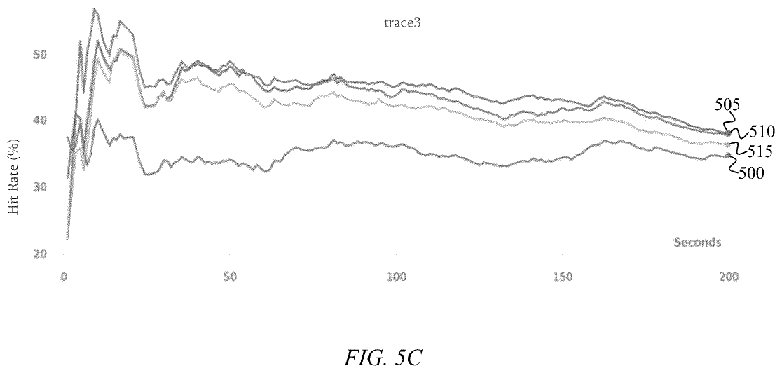

Hit Rate. The maximum hit rates obtained by the Speculative and Reactive SDN setups are compared as well as the average hit rate attained by Speculative SDN against the hit rate attained by Reactive SDN. FIG. 5A-FIG. 5C illustrate the hit rates attained by Reactive SDN 500 and Speculative SDN cases 505 (source-based), 510 (destination-based), 515 (trace-based), each using a different flow ordering method. Speculative SDN 505, 510, 515 consistently performs better than the Reactive case 500, particularly after the initial period. The results also show that the DRL agents learned how to speculate correct flows into the SFT and maintain an edge over Reactive SDN 505. Table III shows the improvement attained by Speculative SDN over Reactive SDN in terms of average or maximum hit rates. A key outcome is that the source-based and destination-based flow ordering methods perform around or above the benchmark, i.e., the trace-based method. This is a very encouraging result, indicating that the spatial locality in the flow arrivals can be captured by ordering the flow IDs based on the source or destination IP addresses. Moreover, the Speculative SDN consistently outperforms Reactive SDN, particularly in terms of the maximum hit rate.

TABLE III
Percentage improvement attained on the average
or maximum hit rates over Reactive SDN

| Flow | Improvement on {Average, Max} Hit Rate (%) | | |
|---|---|---|---|
| Ordering | trace1 | trace2 | trace3 |
| trace-based | {18.48, 58.05} | {15.31, 54.61} | {0.46, 47.28} |
| source-based | {12.91, 55.35} | {18.94, 56.81} | {5.82, 53.81} |
| dest-based | {20.60, 60.25} | {17.72, 56.76} | {4.46, 48.62} |

Speculation Efficiency. A key issue in Speculative SDN is the potential security risk. When flow rules are speculated into the SFT, an opportunity is created for attackers to find more ways to attack the SDN setup. The attackers can send DOS attack packets which can cause system failure or spoof information from the system. Hence, a metric that considers both improving the hit rate and minimizing the number of speculated flows is the speculation efficiency, which is inspected here. Table IV shows the speculation efficiency, which is the marginal improvement attained by Speculative SDN for every one percent of the SFT filled with speculated flows. Except for one case, i.e., the trace-based method on trace3, the speculation efficiency is quite high, showing that adding speculated flows to the SFT may be worth the risk of the increased security risk.

TABLE IV
Speculation Efficiency: Marginal improvement in hit rate
for every one percent of SFT filled w/speculated flows

| Flow | Speculation Efficiency | | |
|---|---|---|---|
| Ordering | trace1 | trace2 | trace3 |
| trace-based | 22.69 | 18.05 | 0.98 |
| source-based | 16.14 | 22.84 | 12.48 |
| destination-based | 24.52 | 21.23 | 10.88 |

In various embodiments, the present invention provides a speculative SDN framework that is capable of predicting the flow arrivals that have no history of appearance using DRL agents. The framework shows that the miss rate at Reactive SDN switches can be significantly reduced, which is crucial for low-latency applications such as online gaming, VR, and AR. The DQN algorithm is used to train the agents to choose the optimal group of flow rules for installation dynamically. Experimental results prove the efficiency and effectiveness of the framework in terms of finding the best group of flow rules in SDNs for low-latency applications. It is believed that the RL-based speculative flow rule installation model in SDNs is capable in other areas of networking that require dynamic traffic speculations.

There are many future directions to pursue in this line of work, including emulating the framework experiments in an actual SDN setup such as the ONOS controller, choose another RL algorithm to enhance the framework results, and perform further tuning of speculative SDN parameters over more traffic traces and explore the trade-off between using fewer RL agents and the capability of learning per-flow patterns. An effort focused on the security aspects on the speculative SDN design is needed to further explore the trade-off between security and efficiency. Going beyond the validity of the speculative SDN framework for a single router at L3, network performance under various traffic types (e.g., UDP vs. TCP and control-vs. data-plane) should all be studied as well.

The present invention may be embodied on various computing platforms that perform actions responsive to software-based instructions and most particularly on touchscreen portable devices. The following provides an antecedent basis for the information technology that may be utilized to enable the invention.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

However, as indicated above, due to circuit statutory subject matter restrictions, claims to this invention as a software product are those embodied in a non-transitory software medium such as a computer hard drive, flash-RAM, optical disk or the like.

Program code embodied on a computer readable medium may be transmitted using any appropriate medium, including but not limited to wireless, wire-line, optical fiber cable, radio frequency, etc., or any suitable combination of the foregoing. Computer program code for carrying out operations for aspects of the present invention may be written in any combination of one or more programming languages, including an object oriented programming language such as Java, C#, C++, Visual Basic or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

It should be noted that when referenced, an “end-user” is an operator of the software as opposed to a developer or author who modifies the underlying source code of the software. For security purposes, authentication means identifying the particular user while authorization defines what procedures and functions that user is permitted to execute.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

1. A software-defined networking (SDN) system, the system comprising:
a plurality of SDN switches, each of the plurality of SDN switches comprising a switch flow table (SFT) for storing flow rules for the SDN switch; and
an SDN controller coupled to the plurality of SDN switches, wherein the SDN controller comprises a speculative SDN application having a plurality of reinforcement learning (RL) agents and wherein the plurality of RL agents are trained to speculate a flow rule for a previously unseen flow and to install the speculated flow rule for the previously unseen flow into the switch flow table (SFT) of one or more of the plurality of switches prior to arrival of the previously unseen flow at the one or more of the plurality of switches.

2. The system of claim 1, wherein the plurality of RL agents are trained to utilize active flow rules in the SFT to speculate the previously unseen flow rules as geographically adjacent to the active flow rules.

3. The system of claim 1, wherein the SDN controller further comprises a reactive SDN application for installing new flow rules into the SFT following a miss at the SFT and wherein the reactive SDN application for installing new flow rules into the SFT of one or more of the plurality of switches coordinates with the speculative SDN application for installing speculative flow rules into the SFT of one or more of the plurality of switches.

4. The system of claim 2, wherein installing the speculative flow rules occurs at a learning time interval (LTI) of one or more of the plurality of SDN switches.

5. The system of claim 2, wherein installing the reactive flow rules occurs at a reactive time interval (RTI) of one or more of the plurality of SDN switches.

6. The system of claim 2, wherein the SDN controller implements a least frequently used (LFU) policy and a priority policy to remove one or more flow rules from the SFT to provide space to install the new flow rules or the speculative flow rules.

7. The system of claim 1, wherein the SDN controller implements a reward policy for the plurality of RL agents to increase ability of the plurality of the plurality of RL agents to predict a best set of speculative flow rules to install into the SFT of one or more of the plurality of switches.

8. A computer implemented method for software-defined networking (SDN), the method comprising:
receiving a previously unseen flow at one or more of a plurality of SDN switches, wherein the plurality of SDN switches comprises a switch flow table (SFT) for storing flow rules;
requesting, from one or more of the plurality of SDN switches, a new flow rule for the previously unseen flow from a speculative SDN application of an SDN controller coupled to the plurality of SDN switches;
speculating by the speculative SDN application of an SDN controller coupled to the plurality of SDN switches, a speculated flow rule for the previously unseen flow; and
installing the speculated flow rule into the SFT of one or more of the plurality of SDN switches.

9. The method of claim 1, wherein the speculative SDN application comprises a plurality of reinforcement learning (RL) agents, the method further comprising training the plurality of reinforcement learning agents to speculate the flow rule for a previously unseen flow and to install the speculated flow rule for the previously unseen flow into the switch flow table (SFT) of one or more of the plurality of switches prior to arrival of the previously unseen flow at the one or more of the plurality of switches.

10. The method of claim 9, wherein training the plurality of RL agents further comprises utilizing active flow rules in the SFT to speculate the previously unseen flow rules as geographically adjacent to the active flow rules.

11. The method of claim 8, wherein the SDN controller further comprises a reactive SDN application, the method further comprising, installing new flow rules into the SFT following a miss at the SFT and coordinating with the speculative SDN application for installing speculative flow rules into the SFT of one or more of the plurality of switches.

12. The method of claim 11, wherein installing the speculative flow rules occurs at a learning time interval (LTI) of one or more of the plurality of SDN switches.

13. The system of claim 11, wherein installing the new flow rules occurs at a reactive time interval (RTI) of one or more of the plurality of SDN switches.

14. The system of claim 11, further comprising, implementing, by the SDN controller, a least frequently used (LFU) policy and a priority policy to remove one or more flow rules from the SFT to provide space to install the new flow rules or the speculative flow rules.

15. The system of claim 12, further comprising, implementing, by the SDN controller a reward policy for the plurality of RL agents to increase ability of the plurality of the plurality of RL agents to predict a best set of speculative flow rules to install into the SFT of one or more of the plurality of switches.

16. A non-transitory computer-readable medium, the computer-readable medium having computer-readable instructions stored thereon that, when executed by a computing device processor, cause the computing device to implement a software-defined networking (SDN) comprising:
receiving a previously unseen flow at one or more of a plurality of SDN switches, wherein the plurality of SDN switches comprises a switch flow table (SFT) for storing flow rules;
requesting, from one or more of the plurality of SDN switches, a new flow rule for the previously unseen flow from a speculative SDN application of an SDN controller coupled to the plurality of SDN switches;
speculating by the speculative SDN application of an SDN controller coupled to the plurality of SDN switches, a speculated flow rule for the previously unseen flow; and
installing the speculated flow rule into the SFT of one or more of the plurality of SDN switches.

17. The computer-readable medium of claim 16, wherein the speculative SDN application comprises a plurality of reinforcement learning (RL) agents, the computer-readable instructions further including, training the plurality of reinforcement learning agents to speculate the flow rule for a previously unseen flow and to install the speculated flow rule for the previously unseen flow into the switch flow table (SFT) of one or more of the plurality of switches prior to arrival of the previously unseen flow at the one or more of the plurality of switches.

18. The computer-readable medium of claim 17, wherein training the plurality of RL agents further comprises utilizing active flow rules in the SFT to speculate the previously unseen flow rules as geographically adjacent to the active flow rules.

19. The computer-readable medium of claim 17, wherein the SDN controller further comprises a reactive SDN application, the computer-readable instructions further including, installing new flow rules into the SFT following a miss at the SFT and coordinating with the speculative SDN application for installing speculative flow rules into the SFT of one or more of the plurality of switches.

20. The computer-readable medium of claim 17, further comprising, implementing, by the SDN controller a reward policy for the plurality of RL agents to increase ability of the plurality of the plurality of RL agents to predict a best set of speculative flow rules to install into the SFT of one or more of the plurality of switches.
